(19) United States
(12) Patent Application Publication
(10) Pub. No.: US 2004/0008712 A1
(43) Pub. Date: Jan. 15, 2004

(54) Communication service unit and communication system

(76) Inventors: Morio Yoshimoto, Tokyo (JP); Shuu Murayama, Tokyo (JP); Yuuji Horii, Tokyo (JP); Susumu Oka, Tokyo (JP)

Correspondence Address: BIRCH STEWART KOLASCH & BIRCH, PO BOX 747, FALLS CHURCH, VA, 22040-0747, US

(21) Appl. No.: 10/203,024

(22) PCT Filed: Jan. 29, 2002
(86) PCT No.: PCT/JP02/00661

(30) Foreign Application Priority Data
Jan. 30, 2001 (JP) 2001-21688

(51) Int. Cl. H04L 12/54

(52) U.S. Cl. 370/428

(57) ABSTRACT

A communication service unit 1 connected with a plurality of communication terminals 3 sends additive information stored in an additive information storing unit 2 before the sending of communication information including visual data, audio data and/or text data sent for an original purpose of communication, while temporarily stopping the sending of the communication information during the communication based on the communication information, or after the completion of the sending of the communication information. Or, a transmission band permitted for the communication information is narrowed in the communication service unit 1 or an instruction is sent from the communication service unit 1 to one communication terminal 3 of a sending end to decrease a transfer rate of the communication information temporarily or from beginning to end of the communication, and the additive information is sent within a transmission band preset for the communication information.

### TECHNICAL FIELD

The present invention relates to a communication service unit connected with a plurality of communication terminals and a communication method in which communication information sent from a communication terminal of a sending-end for an original purpose of communication is received, additive information is added to the communication information when the communication information is sent to a communication terminal of a receiving-end, and the communication information with the additive information is sent to the communication terminal of the receiving-end.

### BACKGROUND ART

As an example, in a conventional communication service guide providing system disclosed in Published Unexamined Japanese Patent Application No. 2000-253326 (2000), additive information such as a communication service guide is multiplexed with communication information sent for an original purpose of communication, and the additive information is transmitted with the communication information.

However, in the conventional communication service guide providing system, the additive information such as a communication service guide is merely multiplexed with communication information, and the additive information is transmitted with the communication information. Therefore, there is a case where a transfer rate of the communication information with the additive information is increased. In this case, if a transmission band of a communication channel for the communication information can be flexibly widened, the additive information can be transmitted with the communication information. In contrast, in cases where the communication channel does not sufficiently have a surplus transmission band not used for the transmission of the communication information, the additive information cannot be transmitted with the communication information.

The present invention is provided to solve the above-described problem, and the object of the present invention is to provide a communication service unit and a communication method in which additive information is transmitted to a communication terminal of a receiving-end even though a communication channel does not sufficiently have a surplus band.

### DISCLOSURE OF THE INVENTION

A communication service unit according to the present invention sends additive information relating to or not relating to the communication based on communication information to a communication terminal of a receiving end within a transmission band permitted for the sending of the communication information before the sending of the communication information, during the sending of the communication information or after the completion of the sending of the communication information.

Therefore, even though a surplus band not actually used for the sending of the communication information does not sufficiently exist in a transmission band permitted for the sending of the communication information, the additive information can be sent to the communication terminal of the receiving end.

A communication service unit according to the present invention is connected with an additive information storing server for storing in advance the additive information, and the additive information stored in the additive information storing server is read out and sent.

Therefore, even though a plurality of communication service units are used, it is not required to store the additive information or renew the additive information for each communication service unit. Accordingly, a manufacturing cost of the communication service unit can be lowered.

In a communication service unit according to the present invention, the additive information and the communication information sent for the original purpose of communication are combined with each other to produce combined information, and the combined information is coded according to a coding method, which is the same as that used for the communication information sent for the original purpose of communication, and is sent.

Therefore, the additive information can be added to the communication information without temporarily stopping the sending of the communication information sent for an original purpose of communication or narrowing a transmission band permitted for the sending of the communication information.

A communication method according to the present invention sends additive information relating to or not relating to the communication based on communication information to a communication terminal of a receiving end within a transmission band permitted for the sending of the communication information before the sending of the communication information, during the sending of the communication information or after the completion of the sending of the communication information.

Therefore, even though a surplus band not actually used for the sending of the communication information does not sufficiently exist in a transmission band permitted for the sending of the communication information, the additive information can be sent to the communication terminal of the receiving end.

### BRIEF DESCRIPTION OF THE DRAWINGS

FIG. 1 is a view showing a communication system including a communication service unit according to a first embodiment of the present invention.

FIG. 2 is an explanatory view showing an example of a transmission timing of both communication information and additive information transmitted from the communication service unit of the first embodiment to a communication terminal.

FIG. 3 is an explanatory view showing another example of a transmission timing of both communication information and additive information transmitted from the communication service unit of the first embodiment to a communication terminal.

FIG. 4 is an explanatory view showing another example of a transmission timing of both communication information and additive information transmitted from the communication service unit of the first embodiment to a communication terminal.

FIG. 5 is an explanatory view showing another example of a transmission timing of both communication information and additive information transmitted from the communication service unit of the first embodiment to a communication terminal.

FIG. 6 is an explanatory view showing another example of a transmission timing of both communication information and additive information transmitted from the communication service unit of the first embodiment to a communication-terminal.

FIG. 7 is an explanatory view showing another example of a transmission timing of both communication information and additive information transmitted from the communication service unit of the first embodiment to a communication terminal.

FIG. 8 is an explanatory view showing another example of a transmission timing of both communication information and additive information transmitted from the communication service unit of the first embodiment to a communication terminal.

FIG. 9 is an explanatory view showing another example of a transmission timing of both communication information and additive information transmitted from the communication service unit of the first embodiment to a communication terminal.

FIG. 10 is an explanatory view showing another example of a transmission timing of both communication information and additive information transmitted from the communication service unit of the first embodiment to a communication terminal.

FIG. 11 is an explanatory view showing another example of a transmission timing of both communication information and additive information transmitted from the communication service unit of the first embodiment to a communication terminal.

FIG. 12 is an explanatory view showing another example of a transmission timing of both communication information and additive information transmitted from the communication service unit of the first embodiment to a communication terminal.

FIG. 13 is a view showing a communication system including a communication service unit according to a second embodiment of the present invention.

FIG. 14 is a view showing a communication system including a communication service unit according to a third embodiment of the present invention.

### BEST MODE FOR CARRYING OUT THE INVENTION

Hereinafter, the best mode for carrying out the present invention will now be described with reference to the accompanying drawings to explain the present invention in more detail.

Embodiment 1

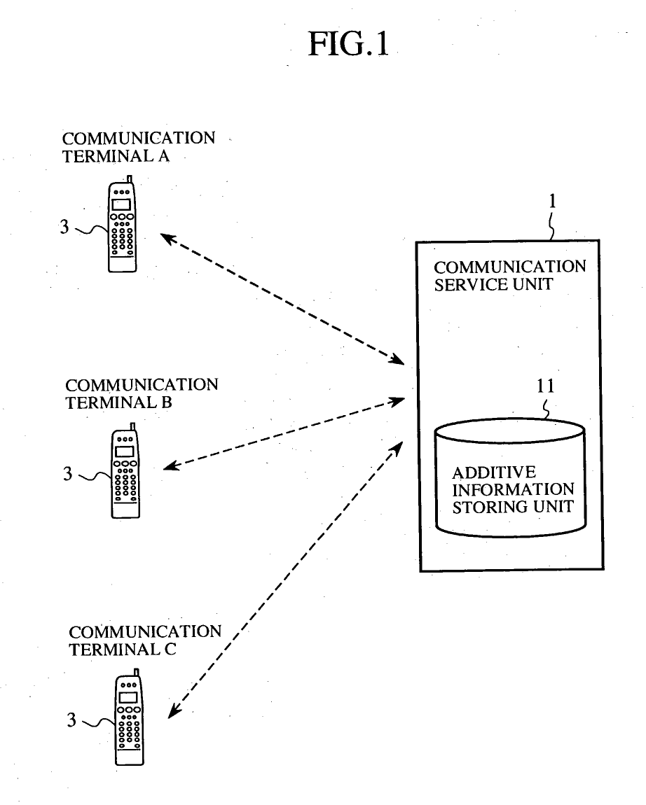

FIG. 1 is a view showing a communication system including a communication service unit according to a first embodiment of the present invention. In FIG. 1, 1 indicates a communication service unit for providing various types of communication services such as a multi-point communication service for each of a plurality of communication terminals 3, adding additive information to communication information and sending the communication information with the additive information to each communication terminal 3. 3 indicates the plurality of communication terminals for respectively receiving the various types of communication services from the communication service unit 1. 11 indicates an additive information storing unit for storing multimedia information such as audio data, visual data and text data as additive information.

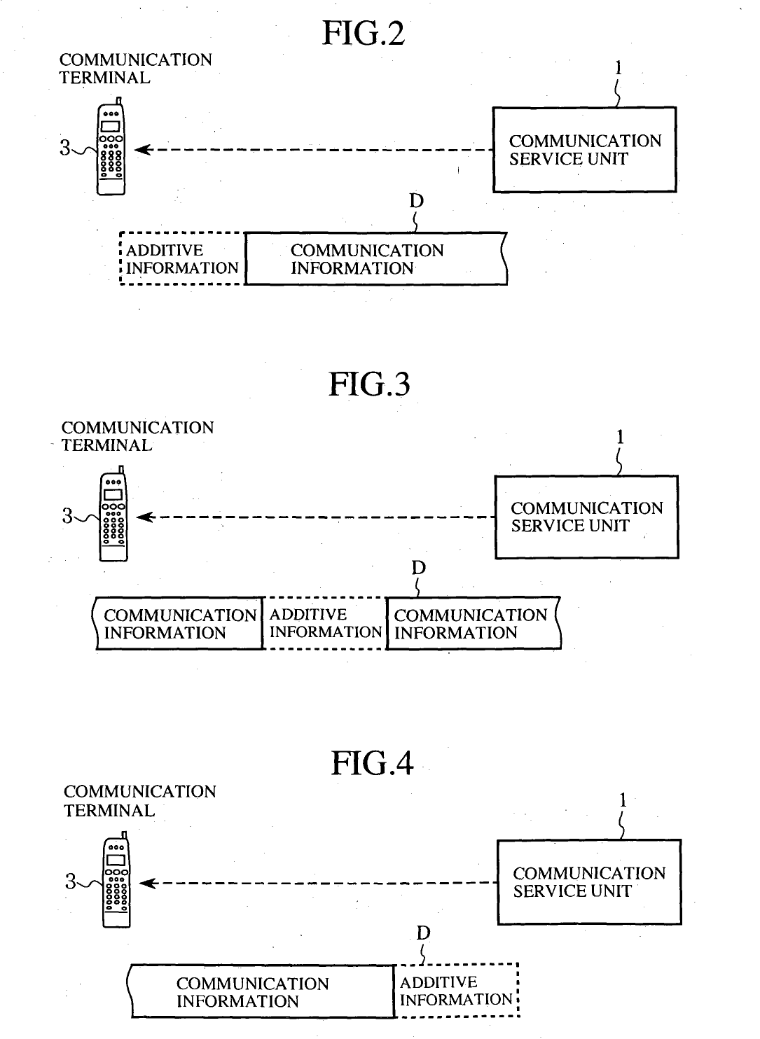

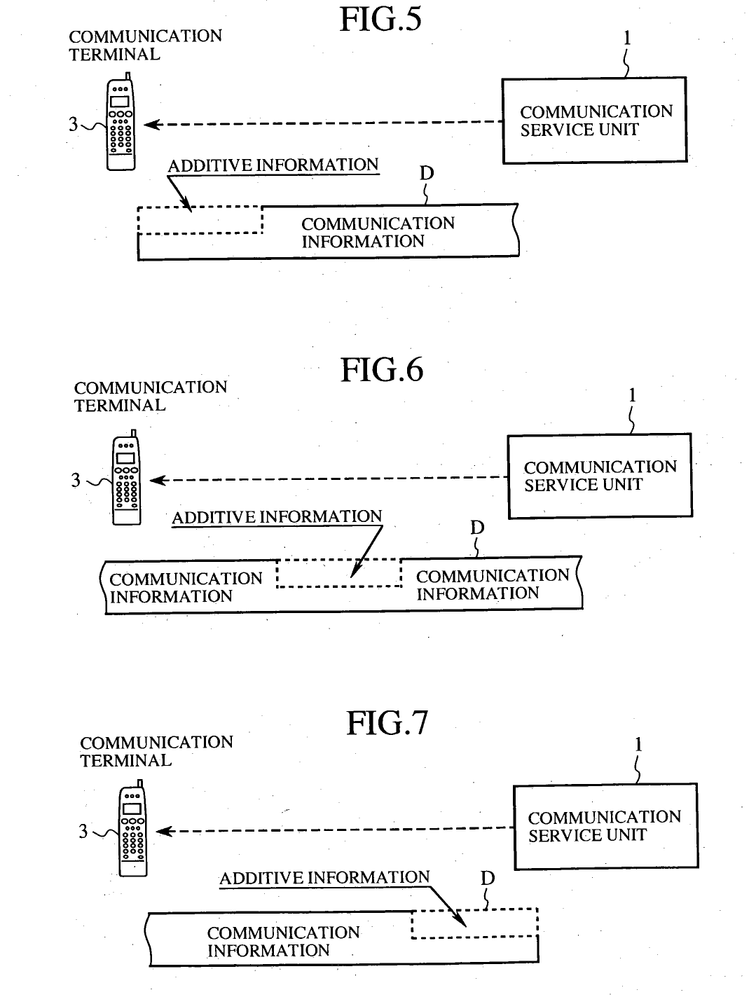

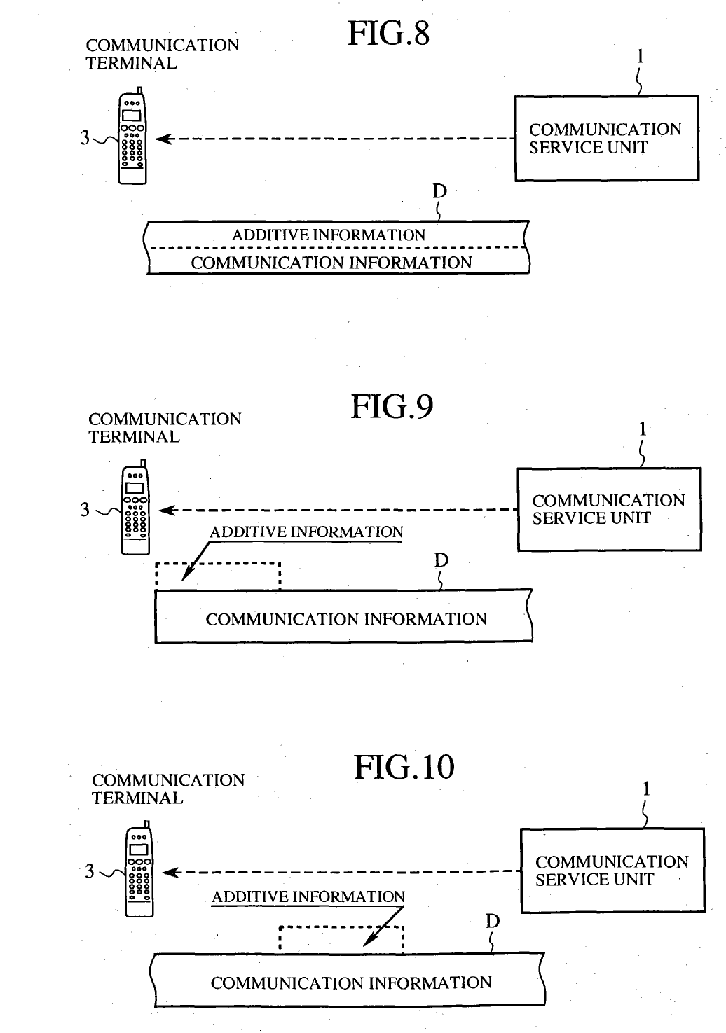

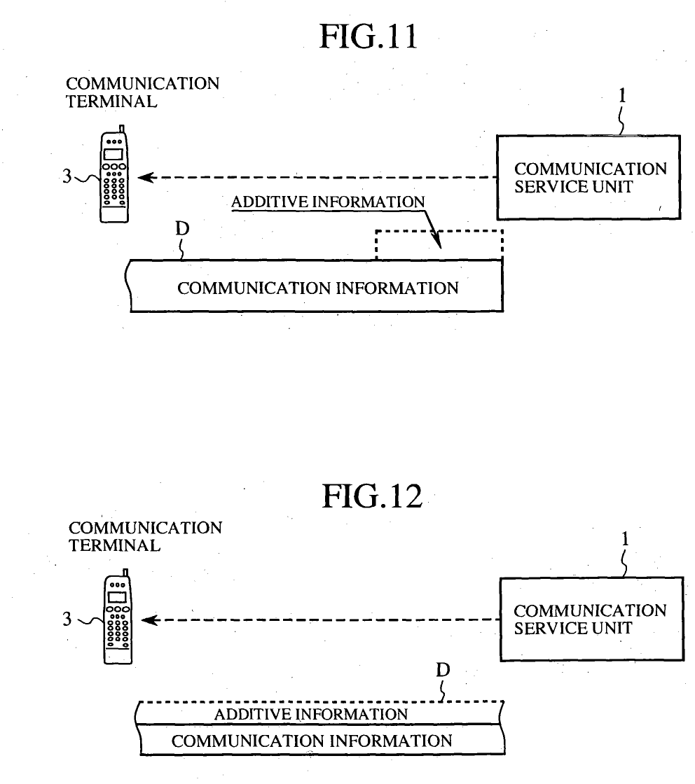

Each of FIG. 2, FIG. 3, FIG. 4, FIG. 5, FIG. 6, FIG. 7, FIG. 8, FIG. 9, FIG. 10, FIG. 11 and FIG. 12 is an explanatory view showing an example of a transmission timing of both communication information and additive information sent from the communication service unit 1 of the first embodiment to each communication terminal 3. In FIG. 2 to FIG. 12, 1 indicates the communication service unit for providing various types of communication services such as a multi-point communication service for each communication terminal 3, adding additive information to communication information and sending the communication information with the additive information to the communication terminal 3. D denotes communication data (communication information and additive information) transmitted between the communication service unit 1 and the communication terminal 3. 3 indicates each of the communication terminals for receiving the various types of communication services from the communication service unit 1.

Next, an operation will be described below.

As shown in FIG. 2, when the communication service unit 1 is connected with each communication terminal 3, the communication service unit 1 provides a normal type of communication service such as a multi-point communication service for the communication terminal 3. In addition, in the communication service unit 1, additive information stored in the additive information storing unit 11 is added to communication information which is originally planned to be sent to the communication terminal 3, and the communication information and the additive information are sent to the communication terminal 3. In this case, before the communication service unit 1 sends the communication information including audio data, visual data and text data to the communication terminal 3 for the original purpose of communication, the communication service unit 1 sends the additive information stored in the additive information storing unit 11. In another concept of the first embodiment, as shown in FIG. 3, the communication service unit 1 temporarily stops the sending of the communication information during the communication based on the communication information, and the communication service unit 1 sends the additive information stored in the additive information storing unit 11. In another concept of the first embodiment, as shown in FIG. 4, the communication service unit 1 sends the communication information for the original purpose of communication. When the sending of the communication information is completed, the communication service unit 1 sends the additive information stored in the additive information storing unit 11. Here, in the communication data D shown in each of FIG. 2 to FIG. 12, the additive information is indicated by a dotted line.

Each communication terminal 3 possible to communicate with the communication service unit 1 receives the additive information from the communication service unit 1 according to the transmission form shown in FIG. 2, FIG. 3 or FIG. 4 in addition to the communication information sent from the communication service unit 1 for the original purpose of communication.

In the above-described operation shown in FIG. 2, FIG. 3 or FIG. 4 the transmission timing of the additive information sent from the communication service unit 1 to the communication terminal 3 differs from that of the communication information. However, the first embodiment is not limited to this operation. For example, it is applicable that a transmission band of a communication channel for the communication information be narrowed on the end of the communication service unit 1 to obtain a transmission band for the sending of the additive information and to transmit the additive information while using the transmission band for the additive information. Also, it is applicable that the communication service unit 1 send an instruction to a communication terminal 3 placed on a sending-end of the communication information to narrow a transmission band of a communication channel for the communication information in the sending-end communication terminal 3 and to send the additive information from the communication service unit 1 to a communication terminal 3 of a receiving-end while using a portion of the transmission band, not used for the sending of the communication information, for the additive information. In detail, as shown in each of FIG. 5 to FIG. 8, a data transfer rate of the communication information sent for the original purpose of communication is reduced temporarily or from beginning to end during the sending of the communication information to obtain a free band not used for the sending of the communication information, and the additive information is sent by using the free band. Therefore, the additive information can be added to the communication information, and the additive information added to the communication information can be sent to a communication terminal 3 of a receiving-end while keeping a transmission band of a communication channel preset for the communication information for the original purpose of communication and without delaying the start time of the sending of the communication information originally set, stopping the sending of the communication information or restricting the sending of the additive information to a time coming after the completion of the sending of the communication information.

In other words, FIG. 5 shows a case where the sending of the additive information is started simultaneously with the start of the sending of the communication information while keeping a transmission band of a communication channel preset for the communication information. In this case, the additive information can be added to the communication information, and the additive information added to the communication information can be sent while keeping a transmission band of a communication channel preset for the communication information and without delaying the start time of the transmission of the communication information originally set. For example, in cases where the communication information to be sent denotes multimedia information having audio data, visual data and text data multiplexed with each other, important data and audio data extracted from the multimedia information are multiplexed with the additive information, and the important data and the audio data are sent with the additive information while keeping a transmission band of a communication channel preset for the communication information and without delaying the start time of the transmission of the communication information originally set. In another concept, it is applicable that prescribed visual data be first sent and the additive information be secondly sent with multimedia data having remaining visual data, audio data and text data multiplexed with each other.

Also, as shown in FIG. 6 and FIG. 7, it is preferred that the additive information be sent with the communication information during the narrowing of a transmission band actually used for the sending of the communication information while keeping a transmission band of a communication channel preset for the communication information and within a range of the transmission band preset for the communication information. For example, in cases where the communication information to be sent denotes multimedia information having audio data, visual data and text data multiplexed with each other, the visual data is compressed and coded according to MPEG4 or the like. When a transmission data amount of the visual data is decreased, for example, due to the decrease of the motion of a background indicated by the visual data, or when either audio data or text data is not sent, the additive information is added to the communication information, and the additive information added to the communication information is sent. In this case, the additive information can be added to the communication information, and the additive information added to the communication information can be sent while keeping a transmission band of a communication channel preset for the communication information and without stopping the sending of the communication information originally planned.

Also, in each of FIG. 2 to FIG. 8, the additive information is multiplexed with the communication information by using or narrowing the transmission band for the communication information, and the additive information multiplexed with the communication information is sent by using the communication channel provided for the communication service of the communication information. However, the communication system including the communication service unit 1 according to the present invention is not limited to these cases. For example, on condition that the additive information multiplexed with the communication information is sent within a range of the transmission band preset for the communication information, it is applicable that an additional data transmission logical path different from the communication channel provided for the communication service of the communication information be set so as to send the additive information by using the additional data transmission logical path.

Also, as shown in FIG. 9 to FIG. 11, on condition that the additive information is sent within a range of the transmission band preset for the communication information, it is applicable that an additional transmission band is temporarily added to the transmission band preset for the communication information so as to send the additive information by using the additional transmission band. Also, in another concept, as shown in FIG. 12, it is applicable that an additional transmission band is added to the transmission band preset for the communication information from beginning to end of the communication based on the communication information so as to send the additive information by using the additional transmission band. Therefore, the additive information can be sent without giving adverse influence on the transmission band for the communication information sent for the original purpose of communication.

Also, in the above-described operation, a call of the communication channel used to send the additive information is not described. However, in the communication system including the communication service unit 1 according to the first embodiment, even though a communication channel set by the same call as that setting the communication channel of the communication information is used for the sending of the additive information, the additive information can be sent without giving adverse influence on the transmission band for the communication information sent for the original purpose of communication. Also, even though a communication channel is newly set by an independent call different from a call setting the communication channel of the communication information to send the additive information by using a communication channel set by the independent call, the additive information can be sent without giving adverse influence on the transmission band for the communication information sent for the original purpose of communication.

Also, it is applicable that contents of the additive information added to the communication information be formed of information relating to communication. For example, it is applicable that guide information indicating a method of using a communication service be sent as additive information. In this case, a user using the communication service can receive the communication service according to the guide information sent from the communication service unit 1, and the user can easily and conveniently receive the communication service.

Also, in cases where contents of the additive information added to the communication information do not directly relate to communication and are, for example, formed of advertisement information made by a third person denoting an advertiser, it is applicable that the advertiser of the advertisement information pay a charge for the communication service in place of a user of a receiving-end communication terminal 3 on condition that the user watches the advertisement information of the additive information sent from the communication service unit 1. In this case, the communication information can be sent free of charge. Therefore, a new business form can be created.

Also, in cases where contents of the additive information added to the communication information are written by a markup describing language (or a markup language), guide information having an easily usable user interface and indicating a method of using interactive communication services can be provided for users of the communication terminals 3, and the convenience of the communication services for the users can be heightened. Also, after each user watches advertisement information denoting additive information, it is preferred that the user is urged to select a prescribed image displayed on a display of the communication terminal 3 for the purpose of confirming that the user watches advertisement information. Therefore, the advertiser can reliably confirm the performance and diffusion of the contents of the advertisement information.

Also, in cases where the additive information is coded according to the same coding method as that used for the communication information, each communication terminal 3 is not required to support a plurality of coding methods. Therefore, the manufacturing cost of the communication terminal 3 can be lowered.

Also, it is preferred that coding methods be unified to one coding method. For example, in cases where the sending of the communication information is temporarily stopped to insert the additive information into the communication information, it is preferred that a codec is not changed to another one. Therefore, the additive information can be smoothly inserted into the communication information while reducing the adverse influence based on the difference between the communication information and the additive information.

Also, it is preferred that the additive information is coded according to a coding method different from that for the communication information and is added to the communication information, the additive information is compressed by using another coding method having a high degree of compression to reduce a transmission band actually used for the additive information, a temporary stopping time period required to obtain an inserted band used for the additive information in the sending of the communication information is shortened, and a reduced width of the transmission band for the communication information is made small.

As is described above, in the first embodiment, in cases where the additive information is added to the communication information sent for the original purpose of communication, the additive information is sent before the sending of the communication information, during the stoppage of the sending of the communication information or after the completion of the sending of the communication information. Therefore, the additive information can be sent within a transmission band preset for the communication information.

Also, the additive information is sent by using a free transmission band existing within a transmission band preset for the sending of the communication information or by setting an additional data transmission logical path. Therefore, the additive information can be added to the communication information, and the additive information added to the communication information can be sent to the receiving-end communication terminal 3 while keeping a transmission band of a communication channel preset for the communication information for the original purpose of communication and without delaying the start time of the sending of the communication information originally set, stopping the sending of the communication information or restricting the sending of the additive information to a time coming after the completion of the sending of the communication information.

Also, an additional transmission band different from a transmission band used for the communication information is obtained temporarily or from beginning to end during the communication based on the communication information on condition that the additional transmission band is placed within a transmission band preset for the communication information, and the additive information is sent by using the additional transmission band. Also, in another concept, an independent call different from a call setting the communication channel of the communication information is newly set, and the additive information is sent by using the communication channel set by the independent call. Therefore, the additive information can be sent without giving adverse influence on the transmission band actually used for the communication information for the original purpose of communication.

Also, because guide information indicating a method of using a communication service is set as additive information, the user can easily and conveniently receive the communication service.

Also, because advertisement information made by a third person denoting an advertiser is set as additive information, in cases where the advertiser of the advertisement information pays a charge for the communication service in place of the user on condition that the user watches the advertisement information of the additive information sent from the communication service unit 1, the communication information can be sent free of charge. Therefore, a new business form can be created.

Also, because the additive information is written by a markup describing language, guide information having an easily usable user interface and indicating a method of using interactive communication services can be provided for users of the communication terminals 3. Therefore, the convenience of the communication services for the users can be heightened. Also, the advertiser can reliably confirm the performance and diffusion of the contents of the advertisement information.

Also, because the additive information is coded according to the same coding method as that used for the communication information, the manufacturing cost of the communication terminal 3 can be reduced. Also, because the coding method for the additive information is the same as that for the communication information, in cases where the sending of the communication information is temporarily stopped to insert the additive information into the communication information, the additive information can be smoothly inserted into the communication information while reducing the adverse influence based on the difference between the communication information and the additive information.

Also, because the additive information is coded according to a coding method different from that used for the communication information, in cases where a degree of compression for the additive information is lowered than that for the communication information, a temporary stopping time period required to obtain an inserted band for the additive information in the sending of the communication information can be shortened. Also, because the coding methods of the additive information and the communication information are different from each other, a level of the maintenance of the communication system including a communication service unit according to the first embodiment can be improved, and the convenience of the contents management can be improved.

Embodiment 2

In the first embodiment, even though a surplus band not used for the sending of the communication information does not sufficiently exist in a transmission band permitted for the sending of the communication information, the additive information can be sent to the communication terminal 3. Next, in a second embodiment, contents of the additive information are stored in a plurality of communication service units in common.

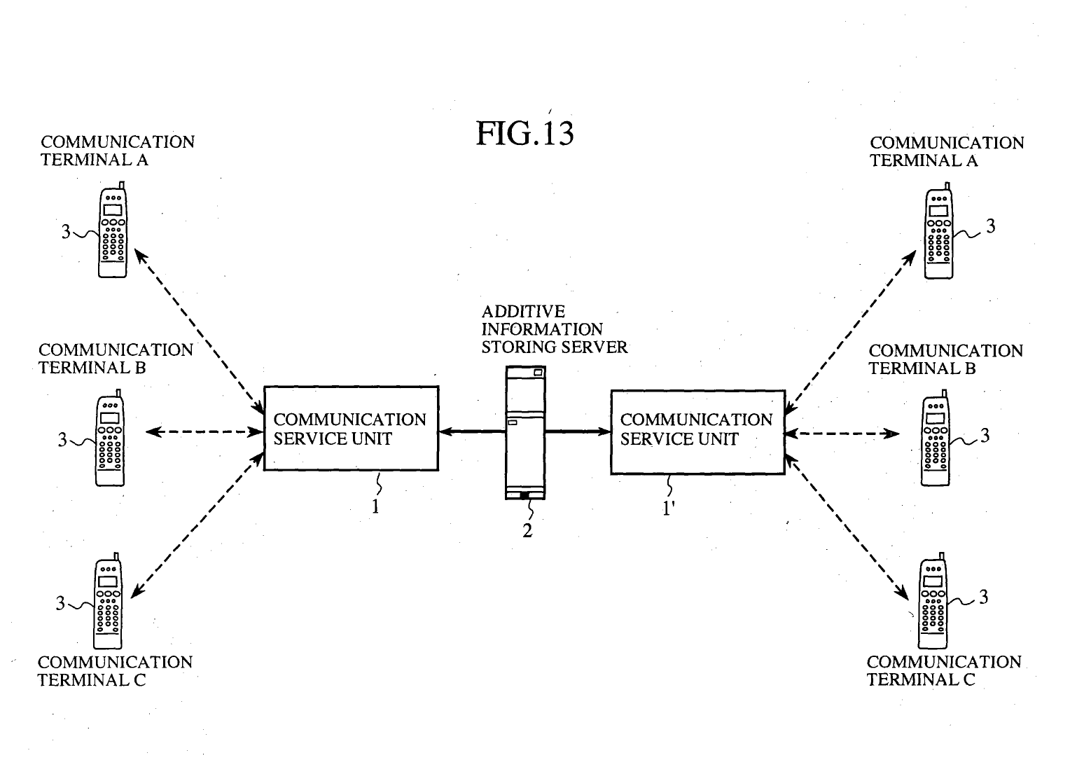

FIG. 13 is a view showing a communication system including a communication service unit according to a second embodiment of the present invention. In FIG. 13, 1 and 1′ indicate a plurality of communication service units for respectively providing various types of communication services such as a multi-point communication service for each communication terminal 3, adding additive information to communication information and sending the communication information with the additive information to the communication terminal 3. 2 indicates an additive information storing unit, placed outside of the communication service units 1 and 1′, for storing multimedia information such as audio data, visual data and text data as additive information. 3 indicates each of the communication terminals for respectively receiving the various types of communication services from the communication service unit 1 or 1′. In the second embodiment, there are two communication service units 1 and 1′ in the communication system. However, it is applicable that three communication service units or more be placed in the communication system.

Next, an operation will be described below.

When each of the communication service unit 1 and the communication service unit 1′ is connected with the corresponding communication terminals 3, each of the communication service units 1 and 1′ provides a normal type of communication service such as a multi-point communication service for the communication terminals 3. In addition, each of the communication service units 1 and 1′ obtains multimedia information stored in the additive information storing unit 2 as additive information, the additive information is added to communication information originally planned to be sent, and the additive information and the communication information are sent to each communication terminal 3.

Each communication terminal 3 communicating with the corresponding communication service unit 1 or 1′ receives the additive information in addition to the communication information sent for the original purpose of communication.

Here, in the description of the second embodiment, the additive information storing unit 2 is arranged in addition to the communication service units 1 and 1′. However, the second embodiment is not limited to this configuration. For example it is applicable that the additive information storing unit 2 be placed inside one of the communication service units 1 and 1′ and the additive information stored in the additive information storing unit 2 be transferred to the other communication service unit.

As is described above, in the second embodiment, each of the communication service unit 1 and the communication service unit 1′ obtains the additive information from the additive information storing unit 2 arranged in common to both the communication service units 1 and 1′, and the additive information is added to the communication information sent for the original purpose of communication. Therefore, it is not required to dispose an additive information storing unit in each of the communication service units 1 and 1′, and the manufacturing cost of the communication service unit 1 can be suppressed.

Also, when contents of the additive information are renewed, the additive information sent from both the communication service unit 1 and the communication service unit 1′ can be renewed by renewing only the stored information of the additive information storing unit 2. Therefore, it is not required to separately renew both stored information of the communication service unit 1 and stored information of the communication service unit 1′. Accordingly, a level of the maintenance of the communication system including a communication service unit according to the first embodiment can be improved, and the convenience of the contents management can be improved.

Embodiment 3

In the second embodiment, the plurality of communication service units 1 and 1′ hold contents of the additive information in common. Next, in a third embodiment, the additive information is displayed in each communication terminal.

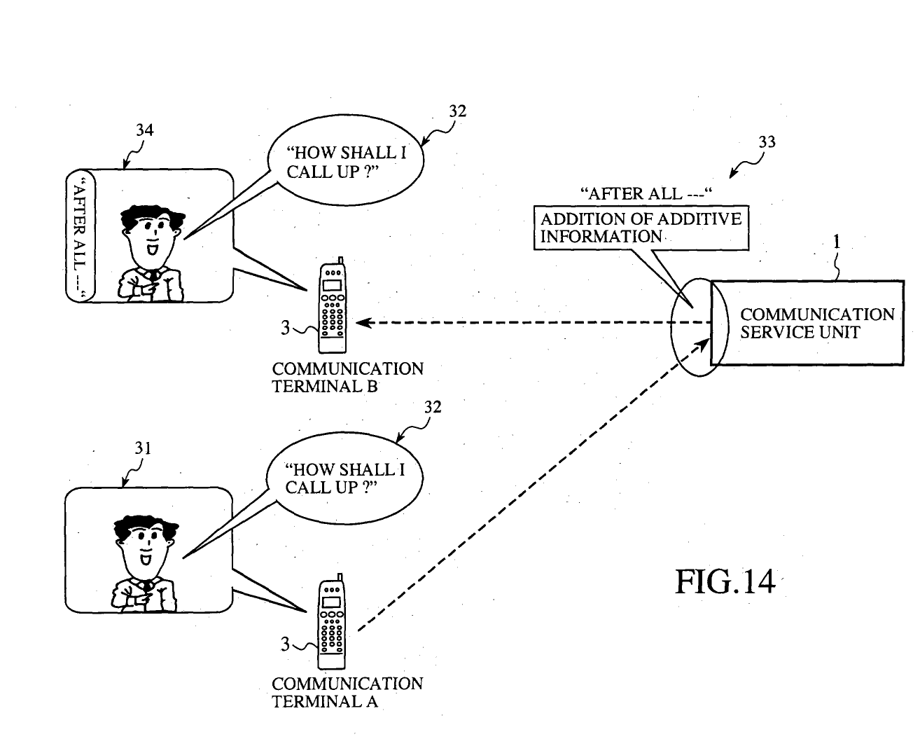

FIG. 14 is a view showing a communication system including a communication service unit according to a third embodiment of the present invention.

1 indicates a communication service unit for providing various types of communication services for each communication terminal 3, adding additive information to communication information and sending the communication information with the additive information to the communication terminal 3. 3 indicates each of the communication terminals for receiving the various types of communication services from the communication service unit 1.

Next, an operation will be described below.

The communication service unit 1 is connected with each communication terminal 3, and the communication service unit 1 provides a normal type of communication service such as a multi-point communication service for the communication terminal 3. Also, in cases where the communication service unit 1 sends the additive information added to the communication information to each communication terminal 3, the communication service unit 1 combines the additive information with the communication information sent for the original purpose of communication to produce combined information. Thereafter, the combined information is coded according to the same coding method as that for the communication information sent for the original purpose of communication, and the combined information is sent from the communication service unit 1 to each communication terminal 3 receiving the communication service.

For example, as shown in FIG. 14, multimedia information composed of image information 31 indicating a picture of a sender A and audio information 32 indicating a speech of “How shall I call up ?” is produced by the sender A of one communication terminal 3, the communication terminal 3 of the sender A sends the multimedia information composed of the image information 31 and the audio information 32 to the communication service unit 1 as communication information. In the communication service unit 1, data (or text) information indicating a text of “after all - - - ” is produced as additive information 33, and the additive information 33 is combined with the communication information having the image information 31 and the audio information 32 sent from the communication terminal 3 of the sender A to produce combined information composed of the additive information 33 and the communication information. Thereafter, the communication service unit 1 sends the combined information having the additive information 33 and the communication information to another communication terminal 3 of a receiver B. In the communication terminal 3 of the receiver B, the audio information 32 indicating the speech of “How shall I call up ?” is output from a speaker of the communication terminal 3, both the image information 31 sent from the communication terminal 3 of the sender A and the additive information 33 indicating the text of “after all - - - ” added in the communication service unit 1 are display-combined with each other on a display of the communication terminal 3 of the receiver B as image information 34, and the image information 34 having both the image information 31 and the additive information 33 is displayed on the display of the communication terminal 3 of the receiver B.

Therefore, in each communication terminal 3 communicating with the communication service unit 1, the combined information sent from the communication service unit 1 is received, and the additive information is obtained in addition to the communication information sent for the original purpose of communication.

Also, in cases where the additive information formed of visual information is processed in the communication service unit 1, it is preferred that the visual information is coded according to a coding method such as MPEG4, the communication information is coded as an object different from that of the visual information, and the combined information is produced by combining both the additive information formed of the visual information and the communication information according to an object coding combination method.

In the above-described operation, the display-combination method of the image information (or the visual information) and the data information (or the text information) is performed as an example of the combination of the communication information and the additive information. However, the third embodiment is not limited to this combination. For example, in cases where audio information is processed as additive information in the communication service unit 1, it is preferred that the additive information and the communication information sent for the original purpose of communication are combined with each other by combining the audio information with the communication information according to an audio addition method.

As is described above, in the third embodiment, in cases where the additive information is added to the communication information in the communication service unit 1, the additive information and the communication information sent for the original purpose of communication are combined with each other to produce combined information, and the combined information is coded in the communication service unit 1. Therefore, in the communication service unit 1, the additive information is coded according to the same coding method as that for the communication information, and the additive information and the communication information can be sent to each communication terminal 3, and the communication information combined with the additive information can be received in the communication terminal 3.

Also, because the combined information produced by combining the additive information with the communication information sent for the original purpose of communication is sent to each communication terminal 3, the additive information can be sent with the communication information without temporarily stopping the sending of the communication information or narrowing the transmission band of the communication information.

Also, in cases where the additive information is formed of visual information, the additive information is coded as an object different from that of the communication information according to the coding method such as MPEG4, and the combined information is produced by combining the communication information and the additive information according to an object coding combination method. Therefore, the additive information can be added to the communication information without causing the deterioration of the communication information due to a coding operation again performed.

Also, in cases where audio information is processed as additive information in the communication service unit 1, the additive information and the communication information are combined with each other by combining the audio information with the communication information according to an audio addition method. Therefore, the additive information formed of audio information can be sent with the communication information without temporarily stopping the sending of the communication information or narrowing the transmission band of the communication information.

### INDUSTRIAL APPLICABILITY

As is described above, the present invention is appropriate to a communication service unit and a communication method in which a multi-point communication service obtained by efficiently adding addditive information to communication information originally planned to be sent.

What is claimed is:

1. A communication service unit, which is connected with a plurality of communication terminals, receives communication information sent from one communication terminal of a sending end for an original purpose of communication and sends additive information in case of the sending of the communication information to one communication terminal of a receiving end,
characterized in that the additive information relating to or not relating to the communication based on the communication information is sent to the communication terminal of the receiving end within a transmission band permitted for the sending of the communication information before the sending of the communication information, during the sending of the communication information or after the completion of the sending of the communication information.

2. A communication service unit according to claim 1, wherein the additive information to be sent to each communication terminal is stored in advance and is sent.

3. A communication service unit according to claim 1, wherein the communication service unit is connected with an additive information storing server for storing in advance the additive information to be sent to each communication terminal and the additive information stored in the additive information storing server is read out and sent.

4. A communication service unit according to claim 1, wherein the sending of the communication information is temporarily stopped, and the additive information is sent within the transmission band of the communication information.

5. A communication service unit according to claim 1, wherein a transmission band used for the sending of the communication information is narrowed temporarily or from beginning to end of the communication based on the communication information, and the additive information is sent by using a portion of the transmission band not used for the sending of the communication information.

6. A communication service unit according to claim 1, wherein an instruction is sent to the communication terminal of the sending end to decrease a transfer rate of the communication information, and the additive information is sent by using a portion of a transmission band not used for the sending of the communication information within the transmission band permitted for the sending of the communication information.

7. A communication service unit according to claim 1, wherein a transfer rate of the communication information is decreased, and the additive information is sent by using a portion of a transmission band not used for the sending of the communication information within the transmission band permitted for the sending of the communication information.

8. A communication service unit according to claim 1, wherein a data transmission logical path is additionally set within a communication channel used for the sending of the communication information, and the additive information is sent by using the data transmission logical path within the transmission band of the communication channel permitted for the sending of the communication information.

9. A communication service unit according to claim 1, wherein a transmission band different from a transmission band actually used for the sending of the communication information sent for the original purpose of communication is prepared temporarily or from beginning to end of the communication based on the communication information, and the additive information is sent by using the obtained transmission band within the transmission band of the communication channel permitted for the sending of the communication information.

10. A communication service unit according to claim 1, wherein a call of a communication channel independent of a call of a communication channel used for a communication service is newly set, and the additive information is sent within the transmission band of the communication channel permitted for the sending of the communication information.

11. A communication service unit according to claim 1, wherein the additive information is formed of guide information relating to a method of using the communication information currently sent.

12. A communication service unit according to claim 1, wherein the additive information is formed of advertisement information of a third person not directly relating to a method of using the communication information currently sent.

13. A communication service unit according to claim 1, wherein the additive information is written according to a markup language.

14. A communication service unit according to claim 1, wherein the additive information is coded according to a coding method which is the same as that used for the communication information sent for the original purpose of communication.

15. A communication service unit according to claim 1, wherein the additive information is coded according to a coding method which differs from that used for the communication information sent for the original purpose of communication.

16. A communication service unit according to claim 1, wherein the additive information and the communication information sent for the original purpose of communication are combined with each other to produce combined information, and the combined information is coded according to a coding method, which is the same as that used for the communication information sent for the original purpose of communication, and is sent.

17. A communication service unit according to claim 16, wherein the additive information and the communication information are combined with each other according to a display-combination method in a case where the communication information is formed of visual information.

18. A communication service unit according to claim 16, wherein the additive information and the communication information are respectively coded as objects different from each other in a case where the communication information is formed of visual information, and the additive information and the communication information are combined with each other according to an object coding combination method.

19. A communication service unit according to claim 16, wherein the additive information and the communication information are combined with each other according to an audio addition method.

20. A communication method, in which a plurality of communication terminals are connected with each other through a communication service unit, communication information sent from one communication terminal of a sending end for an original purpose of communication is received, and the communication service unit sends additive information when the sending of the communication information to one communication terminal of a receiving end,
characterized in that the communication service unit sends the additive information relating to or not relating to the communication based on the communication information to the communication terminal of the receiving en within a transmission band permitted for the sending of the communication information before the sending of the communication information, during the sending of the communication information or after the completion of the sending of the communication information.
